(19) United States
(12) Patent Application Publication
(10) Pub. No.: US 2026/0033470 A1
(43) Pub. Date: Feb. 5, 2026

(54) Acoustic Shark Repellent Device

(71) Applicant: Courtney Connolly, Soquel, CA (US)

(72) Inventor: Courtney Connolly, Soquel, CA (US)

(21) Appl. No.: 18/794,544

(22) Filed: Aug. 5, 2024

(51) Int. Cl. A01K 79/02

(52) U.S. Cl. CPC A01K 79/02

(57) ABSTRACT

An acoustic shark repellent device includes a housing, a mounting structure to connect the housing to a support structure to be placed underwater in a body of water, a microprocessor positioned in the housing and designed to store recordings or simulations of sounds repellent to sharks, a power unit includes a battery and a power switch positioned in the housing and designed to selectively supply power to the microprocessor, and a speaker assembly positioned in the housing and operatively connected to the microprocessor to emit the sounds repellent to sharks. The sounds may be orca sounds or other repellent sounds.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to shark repellent devices and more particularly pertains to a new acoustic shark repellent device for repelling sharks and discouraging shark attacks using sounds that scare or intimidate sharks, such as orca hunting sounds or other repellent sounds. It is well documented that orcas hunt sharks, so sharks have been known to avoid areas where orcas are present. The acoustic shark repellent device emits simulated or actual recordings of orca sounds to repel sharks and deter them from approaching, thereby reducing potential shark attacks on humans.

### (2) Description of Related Art including information disclosed under 37 CFR 1.97 and 1.98.

The prior art relates to shark repellent devices. The prior art, as best understood, does not disclose an underwater shark repelling device which produces the sound of areas hunting, and where the device is removably attachable to a surfboard or kayak.

### (h) BRIEF SUMMARY OF THE INVENTION

An embodiment of the disclosure meets the needs presented above in a acoustic shark repellent device generally comprising a housing, a mounting structure to connect the housing to a support structure to be placed underwater in a body of water, a microprocessor positioned in the housing and designed to store recordings or simulations of sounds repellent to sharks, a power unit includes a battery and a power switch positioned in the housing and designed to selectively supply power to the microprocessor, and a speaker assembly positioned in the housing and operatively connected to the microprocessor to emit the sounds repellent to sharks. The sounds may be orca sounds or other repellent sounds.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of an acoustic shark repellent device according to an embodiment of the disclosure.

FIG. 2 is a bottom rear perspective view of an embodiment of the disclosure.

FIG. 3 is a side view of an embodiment of the disclosure.

FIG. 4 is a side view of an embodiment of the disclosure in use.

FIG. 5 is a front view of an alternative embodiment of the disclosure.

FIG. 6 is a close-up view of the alternative embodiment of the disclosure.

### (j) DETAILED DESCRIPTION OF THE INVENTION

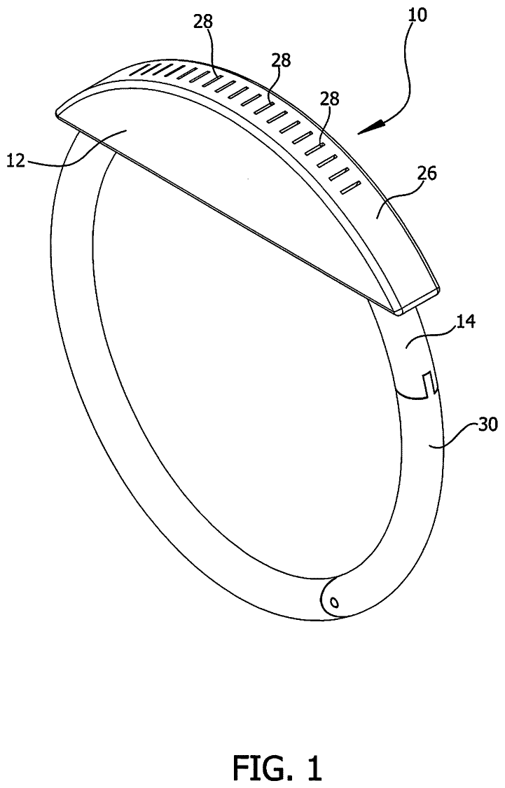

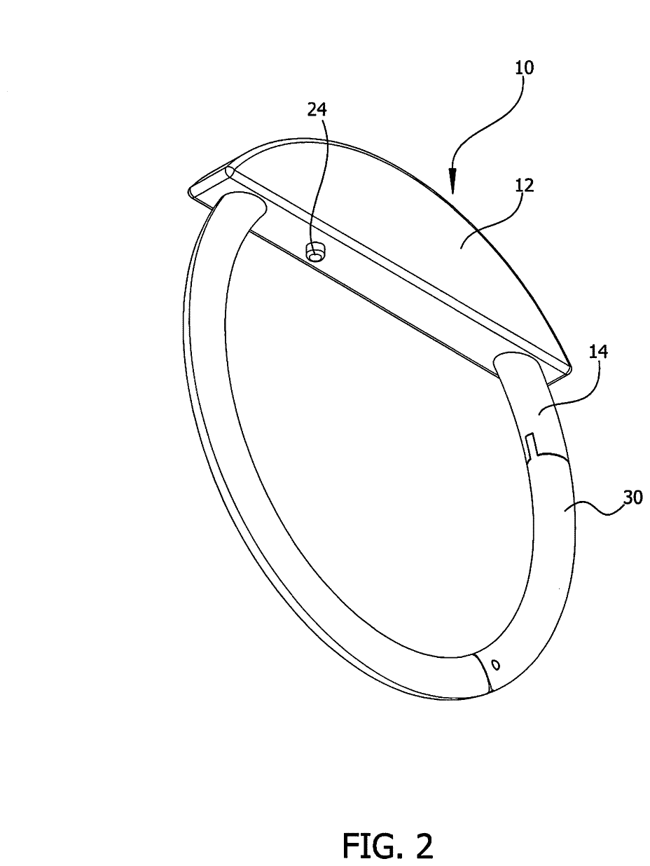

With reference now to the drawings, and in particular to FIGS. 1 through 6 thereof, a new acoustic shark repellent device embodying the principles and concepts of an embodiment of the disclosure and generally designated by the reference numeral 10 will be described.

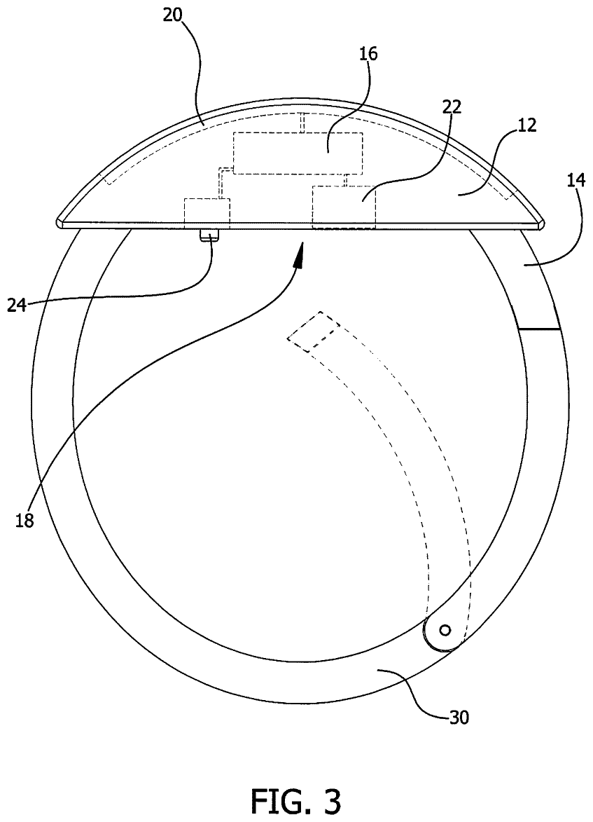

As best illustrated in FIGS. 1 through 6, the acoustic shark repellent device 10 generally comprises a housing 12, a mounting structure 14, a microprocessor 16, a power unit 18, and a speaker assembly 20. As best shown in FIG. 3, the mounting structure 14 connects the housing 12 to a support structure to be placed underwater in a body of water. The microprocessor 16 is positioned in the housing 12 and is designed to store recordings or simulations of sounds repellent to sharks. The power unit 18 includes a battery 22 and a power switch 24 positioned in the housing 12 and designed to selectively supply power to the microprocessor 16. The speaker assembly 20 is positioned in the housing 12 and is operatively connected to the microprocessor 16 to emit the sounds repellent to sharks. In one possible embodiment, the sounds to be emitted are orca sounds, such as orca hunting sounds. However, other sounds that are or may be repellent to sharks, such as the sounds of other creatures or irritating sounds, are within the scope of the disclosure.

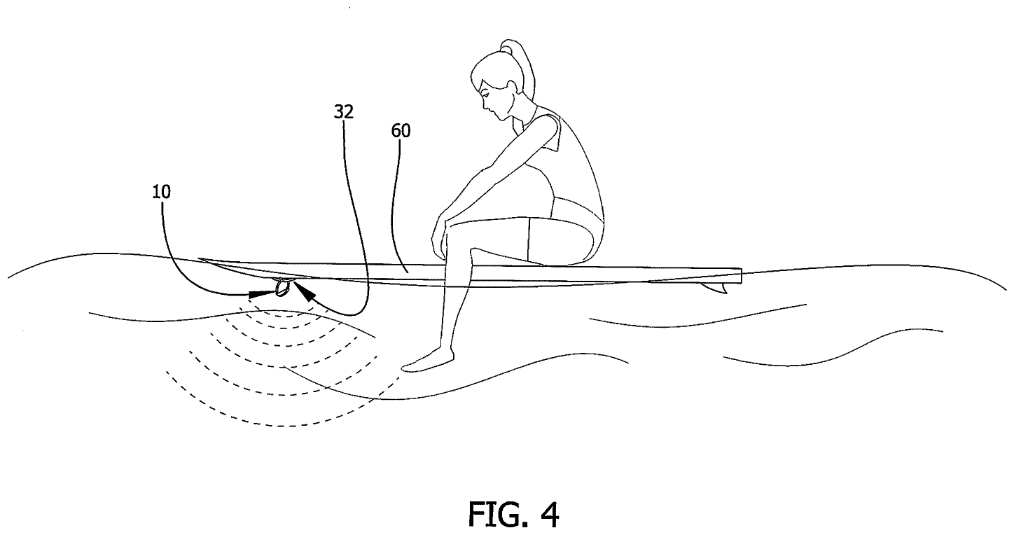

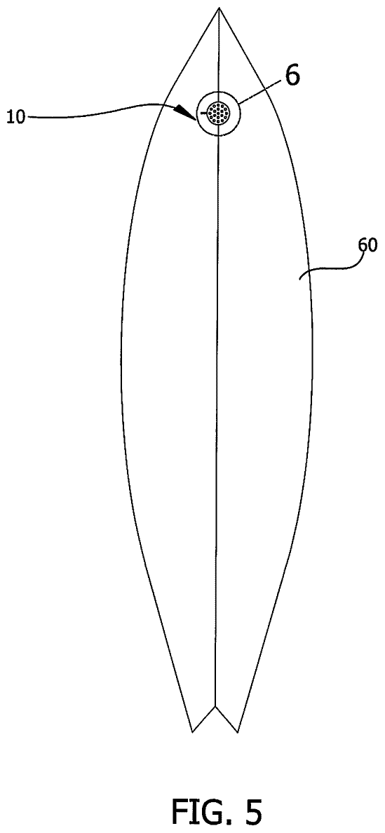

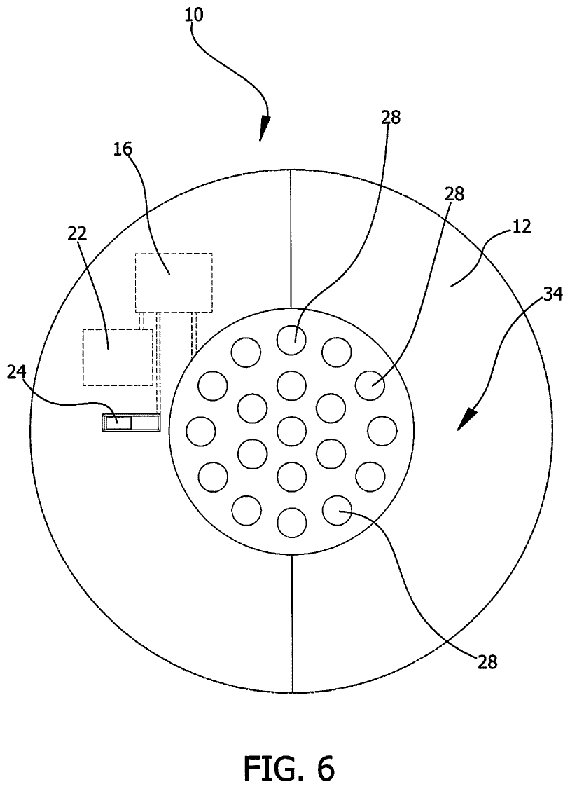

FIGS. 1 through 4 show an exemplary embodiment of a detachable design, whereas FIGS. 5 and 6 show an exemplary embodiment of an integrally or permanently mounted design. As shown in FIGS. 1 though 4 the housing 12 is substantially arch-shaped with a curved outer face 26 that includes orifices 28 therein for the directed emission of sound. The mounting structure 14 includes a detachably connectable ring structure 30, which in the exemplary embodiment shown is in the form of a carabiner with a pivotable portion. As shown in FIG. 4, the mounting structure 14 also includes a mounting strap 32 attachable to a submergible portion of an aquatic board or watercraft 60, to which the ring structure 30 is detachably connected. In one possible embodiment, the mounting strap 32 could be in the form of a strap that is wrappable around the ankle of a person. In another possible embodiment, the ring structure 30 could be in the form of a bracelet or strap or belt for placement on the limbs or waist or other body part of a person. In FIGS. 5 and 6, the housing 12 is substantially disc-shaped with a flat outer face 34 that includes orifices 28 therein for the directed emission of sound. The mounting structure 14 includes a plug-style structure designed to be mounted in a submergible portion of an aquatic board or watercraft 60, such as a surfboard, paddleboard, kayak, or other structure. It should be understood that the designs shown in the figures are exemplary embodiments, and virtually any kind of attachment or design is within the scope of the disclosure. In the exemplary embodiments shown, the acoustic shark repellent device 10 is connected or attached at a front portion of the aquatic board 60. However, the attachment location can be different, but at least should be a submergible portion, such as the underside of an aquatic board or watercraft 60, to ensure that the acoustic shark repellent device 10 is in the water at all times. In addition, the orifices 28 should be oriented facing downwardly into the water to maximize the sound directed into the water.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An acoustic shark repellent device comprising:
a housing;
a mounting structure to connect said housing to a support structure to be placed underwater in a body of water;
a microprocessor disposed in said housing and configured to store recordings or simulations of sounds repellent to sharks;
a power unit comprising a battery and a power switch disposed in said housing and configured to selectively supply power to said microprocessor; and
a speaker assembly disposed in said housing and operatively connected to said microprocessor to emit said sounds repellent to sharks.

2. The acoustic shark repellent device of claim 1, wherein said sounds comprise orca sounds.

3. The acoustic shark repellent device of claim 2, wherein said housing is substantially disc-shaped with a flat outer face comprising orifices therein for the directed emission of sound.

4. The acoustic shark repellent device of claim 2, wherein said housing is substantially arch-shaped with a curved outer face comprising orifices therein for the directed emission of sound.

5. The acoustic shark repellent device of claim 2, wherein said mounting structure comprises a plug-style structure configured to be mounted in a submergible portion of an aquatic board or watercraft.

6. The acoustic shark repellent device of claim 3, wherein said mounting structure comprises a plug-style structure configured to be mounted in a submergible portion of an aquatic board or watercraft.

7. The acoustic shark repellent device of claim 4, wherein said mounting structure comprises a plug-style structure configured to be mounted in a submergible portion of an aquatic board or watercraft.

8. The acoustic shark repellent device of claim 2, wherein said mounting structure comprises a detachably connectable ring structure.

9. The acoustic shark repellent device of claim 8, wherein said ring structure comprises a carabiner.

10. The acoustic shark repellent device of claim 9, wherein said mounting structure comprises a mounting strap attachable to a submergible portion of an aquatic board or watercraft, to which said ring structure is detachably connected.

11. The acoustic shark repellent device of claim 3, wherein said mounting structure comprises a detachably connectable ring structure.

12. The acoustic shark repellent device of claim 11, wherein said ring structure comprises a carabiner.

13. The acoustic shark repellent device of claim 12, wherein said mounting structure comprises a mounting strap attachable to a submergible portion of an aquatic board or watercraft, to which said ring structure is detachably connected.

14. The acoustic shark repellent device of claim 4, wherein said mounting structure comprises a detachably connectable ring structure.

15. The acoustic shark repellent device of claim 14, wherein said ring structure comprises a carabiner.

16. The acoustic shark repellent device of claim 15, wherein said mounting structure comprises a mounting strap attachable to a submergible portion of an aquatic board or watercraft, to which said ring structure is detachably connected.
